(19) United States
(12) Patent Application Publication
(10) Pub. No.: US 2007/0150516 A1
(43) Pub. Date: Jun. 28, 2007

(54) LOCATION TOOLBAR FOR INTERNET SEARCH AND COMMUNICATION

(76) Inventors: Edward J. Morgan, Needham, MA (US); Michael G. Shean, Boston, MA (US); Nicolas Brachet, Chestnut Hill, MA (US)

Correspondence Address: WILMER CUTLER PICKERING HALE AND DORR LLP, 60 STATE STREET, BOSTON, MA, 02109, US

(21) Appl. No.: 11/562,514

(22) Filed: Nov. 22, 2006

Related U.S. Application Data
(60) Provisional application No. 60/738,853, filed on Nov. 23, 2005.
(60) Provisional application No. 60/821,479, filed on Aug. 4, 2006.

(51) Int. Cl. G06F 17/00

(52) U.S. Cl. 707/104.1

(57) ABSTRACT

A utility to invoke web services with information identifying an estimated geographic position of a user. The utility includes a geographic position estimating engine for periodically estimating a geographic position of the user in a first predetermined position information format and a database of website entries stored in an electronically readable medium, each entry specifying a network address of a web service and identifying a corresponding format the web service expects when receiving position information as a web service parameter. The utility also includes logic for detecting web service activation, for accessing the database to identify the expected format for the activated web service, and for invoking transformation logic. The transformation logic transforms position information in the first predetermined format into position information encoded in the identified format for the activated web service. The utility includes logic to issue the web service activation with the position information in the transformed format.

### CROSS REFERENCE TO RELATED APPLICATIONS

This application claims the benefit under 35 U.S.C. § 119(e) of U.S. Provisional Patent Application No. 60/738,853, filed Nov. 23, 2005, entitled Online Location Toolbar For HTML Browser and U.S. Provisional Patent Application No. 60/821,479, filed Aug. 4, 2006, entitled WLAN Positioning System User Location Pulling Mode For Use In Client-Server Systems, which are herein incorporated by reference in their entirety.

### BACKGROUND

1. Field of Invention

This invention is generally related to location based services as well as location based internet search, more specifically to methods and systems of using a device's calculated location to optimize information search and online communications.

2. Discussion of Related Art

Microsoft LocateMe:

Launched in May 2005, LocateMe is a feature of the Virtual Earth product (now renamed Microsoft Live Local). LocateMe downloads a client application to a Windows XP machine that utilizes the 802.11 adapter to scan for nearby wireless signals. Those signals are then sent to the Virtual Earth server over the Internet. The Virtual Earth server contains a collection of wardriving data Microsoft licensed from community wardriving groups. If the user is within range of access points within that database, then LocateMe calculates the user location and plots that location on a Virtual Earth map.

Placelab google maps mashup:

A former researcher for the Intel Placelab group (www.placelab.org) integrated the Placelab positioning technology into a java applet that can be run within a computer's internet browser. That applet attempts to scan for wireless signals and compare those against the wardriving database maintained by Wigle.net.

Open Mobile Alliance—Secure User Plane Location (SUPL) standard:

The SUPL standard is being adopted by wireless service providers as a mechanism for sharing location information across the wireless network. The standard specifies the systems and services that should exist in the infrastructure managed by the operator in order to deliver location services. More information can be obtained at http://www.openmobilealliance.org/release_program/supl_v1_{—}0.htm.

### SUMMARY

The invention provides utilities and methods for performing Internet search and communication based on an estimated user geographic location.

Under another aspect of the invention, a utility invokes web services with information identifying an estimated geographic position of a user. The utility includes a geographic position estimating engine for periodically estimating a geographic position of the user in a first predetermined position information format and a database of website entries stored in an electronically readable medium, each entry specifying a network address of a web service and identifying a corresponding format the web service expects when receiving position information as a web service parameter. The utility also includes logic for detecting web service activation, for accessing the database to identify the expected format for the activated web service, and for invoking transformation logic. The transformation logic transforms position information in the first predetermined format into position information encoded in the identified format for the activated web service. The utility includes logic to issue the web service activation with the position information in the transformed format.

Under another aspect of the invention, the logic for detecting web service activation is invoked in response to a user web browse action.

Under another aspect of the invention, the logic for detecting web service activation is invoked in response to program code included in a website.

Under another aspect of the invention, the geographic position estimating engine estimates the geographic position of the user based on receiving messages from Wi-Fi access points within range of a Wi-Fi enabled device of the user.

Under another aspect of the invention, the position information encoded in the identified format includes at least one of latitude, longitude, street address, city, state, county, zip code, census tract, region, country, and time zone.

### BRIEF DESCRIPTION OF DRAWINGS

In the drawings,

FIG. 1 depicts a system overview;

FIG. 2 depicts a location mapping process;

FIG. 3 depicts a location push flow diagram; and

FIG. 4 depicts a location pull flow diagram.

### DETAILED DESCRIPTION

Embodiments of the present invention described in this document provide systems and utilities that calculate a user's location and then integrate that location into the user's Internet browsing and online communications experience. One embodiment will be referred to as a location toolbar.

Mobility is becoming an increasingly reality for computing system as wireless devices have matured in capability and wireless systems have become more pervasive. With this new mobility has emerged a whole new set of applications and services that not only offer freedom of movement, but also take advantage of the dynamic nature of mobile users. One class of applications leverages the known physical location of the device and tailors the entire information search and communication experience around that location.

Examples of these new uses of the mobile device are finding merchants, products and people nearby the current position of the user. A business traveler may be looking for a nearby coffee shop. They could stop a stranger and ask them directions to the nearest store, or maybe they could call the phone operator, and try to get help. But with new location technology, individuals can use their laptop or phone to, e.g., quickly search for all coffee shops within a half of a mile, and then get turn-by-turn directions from their current location. Other location services include friend finders, emergency response and virtual tour guides.

One of the reasons these services have been slow to take off is that, until recently, the location of mobile devices was not known and not easy to obtain. In recent years, handset makers have begun to add GPS chips into their devices in order to provide this auto-location capability. But that does not include the hundreds of millions of other mobile devices like laptops and personal digital assistants. In addition to this hardware problem, is the lack of an industry standard for sharing location information.

While telecommunications providers have developed some standards for sharing location information across their networks, these standards do not include any systems outside their networks or any content web sites. So even if a device has auto-location capabilities there are few applications and web sites that are prepared to seamlessly accept this information. Each web site or communication vehicle (location channel) describes locations in a different way. Some web sites ask users for their zip code while others ask for a full street address. For an auto-location system to be seamless it needs the ability to supply location information in all these formats.

The location toolbar embodiment of the present invention addresses all of these issues by integrating directly into common user applications such as Internet browsers and email clients. The location toolbar extends the function of an Internet browser by adding auto-location and translating a user's current location into any format the web site accepts. So, the location toolbar simplifies the process of determining a device's location and then tailoring all Internet searches and communications based on that location. The location toolbar leverages the Wi-Fi Positioning System to determine a device location and then map that location to a local search web query or an online communication such as an email.

Embodiments of the present invention build on techniques, systems and methods disclosed in earlier filed applications, including but not limited to U.S. patent application Ser. No. 11/261,848, entitled Location Beacon Database, U.S. patent application Ser. No. 11/261,898, entitled Server for Updating Location Beacon Database, U.S. patent application Ser. No. 11/261,987, entitled Method and System for Building a Location Beacon Database, and U.S. patent application Ser. No. 11/261,988, entitled Location-Based Services that Choose Location Algorithms Based on Number of Detected Access Points Within Range of User Device, all filed on Oct. 28, 2005, the contents of which are hereby incorporated by reference in their entirety. Those applications taught specific ways to gather high quality location data for Wi-Fi access points so that such data may be used in location based services to determine the geographic position of a Wi-Fi-enabled device utilizing such services and techniques of using said location data to estimate the position of a system user. The present techniques, however, are not limited to systems and methods disclosed in the incorporated patent applications. Thus, while reference to such systems and applications may be helpful, it is not believed necessary to understand the present embodiments or inventions.

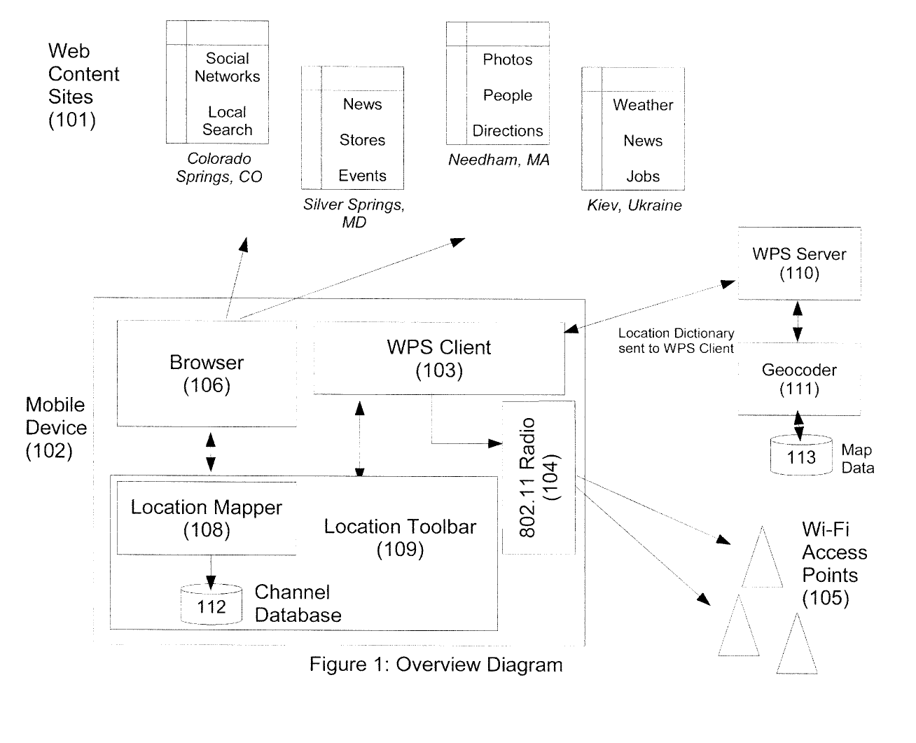

FIG. 1 depicts a system diagram showing the architecture of certain embodiments. A location toolbar (109) is a software application that operates on a mobile device (102) and is installed as an add-on application within an Internet browser like Firefox, Mozilla or Internet Explorer (106). All the major browsers provide the facility for installing additional functionality from another software developer in this manner. The mobile device (102) typically includes a wireless radio (104) configured to communicate using the 802.11 (Wi-Fi) standard of the IEEE.

In an example scenario, a user chooses to search for information on web content sites (101) about merchants nearby their current location. The user selects a location feature of the toolbar (109) that initiates the process. The location feature can include, for example, toolbar buttons or items in a drop-down menu. The toolbar (109) calls the location interface of a WPS (Wi-Fi Positioning System) client (103) and requests the device location.

The WPS client (103) communicates with the 802.11 radio (104) and tells the radio to scan for wireless signals. The radio (104) sends out an active probe request to all nearby access points (105). Each access point (105) that is within range and receives the probe request will respond to the request with a probe response that includes the access point's name and unique identifier (MAC address). The WPS client (103) collects those responses and creates a location query to a WPS server (110) over the Internet.

The WPS server (110) calculates the precise location of the mobile device (102) based on those observed readings and determines the exact latitude and longitude coordinates of the location. Other positioning systems such as GPS, cell tower triangulation or even TV tower triangulation could be used for determining the location . The latitude and longitude outputs from the WPS server (110) are sent to a geocoder (111) that is used to map a coordinate location with a street address location.

Reverse geocoding is a process that takes a latitude and longitude as inputs and calculates the nearest physical street address. The geocoder (111) utilizes street map data (113), such as the US government's TIGER database, to calculate the nearest physical address to the coordinate latitude/longitude location. In certain embodiments, the geocoder (111) performs a reverse geocoding calculation on the latitude and longitude received from the WPS server (110) and returns the street address so that the WPS server (110) can complete an entire location dictionary for the particular location. The WPS server (110) then sends the entire location dictionary for the current location of the device (102) back to the WPS client (103). The location dictionary contains numerous representations of the current location, including elements such as street address, city, state, zip code, etc. for that exact location. An example location dictionary is presented in Table 1.

TABLE 1
Example location dictionary:

element = value
street = Highland avenue
city = Boston
state = Massachusetts
Zip code = 02456
Latitude = 42.56933
Longitude = −71.348820

The location dictionary is passed to the location mapper (108) of the location toolbar (109) via the WPS client (103). The location mapper (108) accesses a channel database (112) of location content and channels that the toolbar currently supports. The channel database (112) tells the location mapper (108) which location elements are required to perform the requested function and how to construct the content request or communication message in the proper syntax and format in order to complete the transaction.

For example, some web sites include the user's location in the URL request for content and that location is in the form of a zip code. A set of default location channels can be included in the channel database (112) when the toolbar (109) is installed in the mobile device (102). Other channels can be downloaded and installed from the online channel gallery on the Internet. These new channels are seamlessly added to the channel database (112) and available for the user. The location mapper (108) converts the current location into the proper message format and returns that to the browser (106). The request is processed by the browser (106) making an http call to the web content site (101) which then responds with the location specific content.

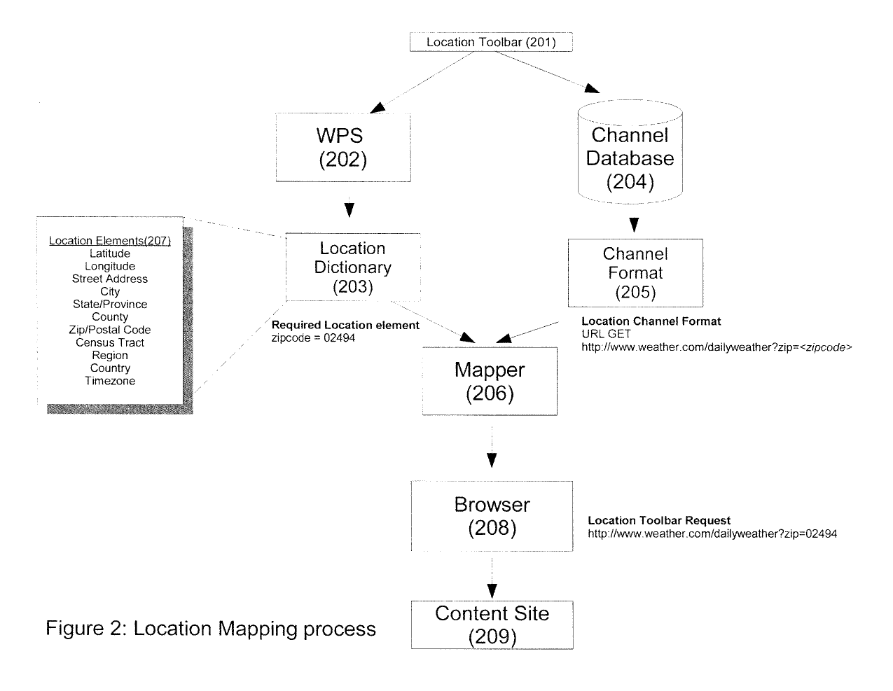

FIG. 2 depicts elements of the location dictionary and location mapper, described above, in more detail. The location mapper (206) acts as a global translator of location information. The location toolbar (201) receives a local content request from a user or a web site. The toolbar (201) calls the WPS system (202) that (as described above) returns a location dictionary (203) containing all of the individual location elements (207) of that particular location. Location information can be expressed in a number of ways because there is no universal standard that exists for internet content searches.

In the technical positioning world of Global Information Systems (GIS), location is often described in the form of a latitude and longitude, components of the spherical coordinate system used to map the location of every location on Earth. But there are even several formats that exist to express a proper latitude and longitude position. In some situations, location is often expressed as a street address, while in others, census tracts are used to collect data for things like demographic surveys and population census records. Every local content web site on the Internet requires the submission of a location in a potentially different format; some need only zip code, while others need latitude/longitude.

The location toolbar needs to be able to speak all of those languages and formats while hiding those complexities from the user. The location dictionary (203) is the complete representation of the current location and includes not only the latitude and longitude but also additional address information such as street address, city, state/province, county, census tract, zip, country and time zone, as well as any other relevant location information. The location toolbar (201) can then decide what location elements (207) in the location dictionary (203) are necessary in order to perform the local content request.

At the same time as the location toolbar (201) is obtaining the location dictionary (203), the toolbar (201) also searches a channel database (204) for the content channel the user requested (weather.com or google maps for example). Each channel has a specific channel format (205) that describes how that web site or communication channel expects location information. That format can be in the form of a URL, a form post, an XML schema, etc. Once the toolbar (201) has the two pieces it needs, it then calls the Mapper (206) that combines the location dictionary (203) and the channel format (205) replacing location variables with their respective location elements (207) (e.g., zipcode =02494). With the content request constructed, the toolbar (201) passes the request off to the browser (208) which then processes the request and contacts the content web site (209) with the specific location query.

For example, a web user may wish to locate all the coffee shops that are nearby their current location. In order to achieve this search, the user enters their search text of “coffee shops” into their favorite local search channel, in this case Yahoo! Local, within the location toolbar (201). The location toolbar (201) requests the user location from the WPS system (202) and receives the location dictionary (203) for the current location. An example of the location dictionary (203) is provided in Table 2.

TABLE 2
Location Dictionary:

element = value
house number = 332
street = Congress St
city = Boston
state = Massachusetts
Zip code = 02456
Latitude = 41.56933
Longitude = −71.377777

The toolbar (201) then checks the channel database (204), within the location mapper (206), and retrieves the location elements (207), the location vehicle and format of the Yahoo! Local Search channel. An example of the required location elements and location channel format (205) is provided in Table 3.

TABLE 3
Yahoo! Local Search Channel

Elements
<search text><housenum>, <street>, <city>, <state>, <zip>
Format
http://local.yahoo.com/search?search=<search text>
&address=<housenum><street>&city=<city>&state=<state>
&zip=<zip>

The location mapper (206) replaces the variable names in the channel format (205) with the actual values from the location dictionary (203). With that information, the toolbar (201) converts the location dictionary (203) into the proper http request required by Yahoo! Local in order to search for coffee shops within a certain range of a particular location. An example of the formatted request is provided in Table 4.

TABLE 4
Final HTTP request

http://local.yahoo.com/search?search=coffee%shops
&address=332%congress%st&city=boston&state=ma
&zip=02456

After the toolbar (201) constructs the request and the browser (208) delivers it to Yahoo! Local (the content site (209)), the content is returned back to the browser and displayed for the user.

This process is carried out for each user request. The location channels can be related to online content or communications. The location toolbar is designed to be extensible so that the user can add new channels of any format at any time. Examples of content channels include local news, weather, merchants & promotions, social networking, travel & directions, events, culture, tourism, and keyword based local search channels. Embodiments of the present invention encompass including formatted location information in emails sent to another person, in text messages sent to another mobile user, or in postings on a Location Sharing Network (LSN). In addition, embodiments are capable of formatting location requests for various constructs, e.g., HTTP URL GET, HTTP FORM POST, Email, and XML.

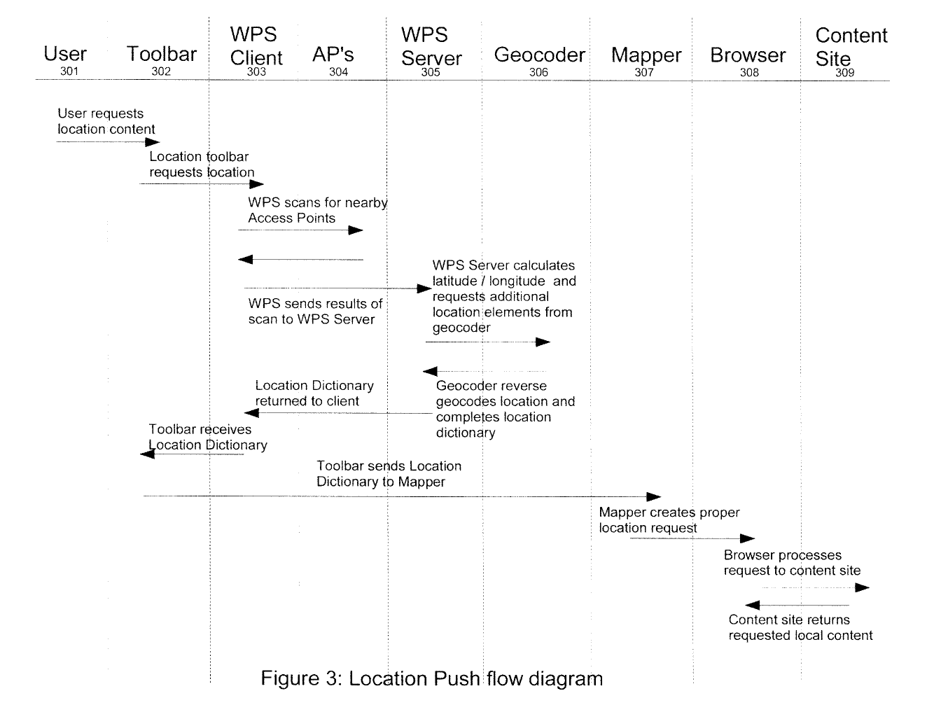

Embodiments of the invention are capable of operating in two illustrative operating modes, a location push model and a location pull model. FIG. 3 depicts a location push model flow diagram. In the location push model, the user (301) initiates a location request or communication by using their location toolbar (302) and making the request that pushes their current location out to the web or another user via email/SMS/instant messenger. An example of a push request is a user searching for a nearby Mexican restaurant for dinner.

The user enters their search keywords (“Mexican restaurant”) into their favorite search channel in the location toolbar (302), such as CitySearch.com. The location toolbar (302) requests the device's current location from the WPS location client (303), which scans for all nearby access points (304). All of the access points (304) in range of the device respond. That collection of access points (304) is packaged up by the WPS client (303) and sent off to the WPS Server (305) to calculate the latitude and longitude of the device. After completing that calculation, the WPS Server (305) uses the geocoder (306) to complete the location dictionary that is sent back down to the WPS client (303) and toolbar (302). The toolbar uses the location mapper (307) to construct the necessary HTTP POST (for example) request that CitySearch expects and sends that to the browser (308) for processing. Upon delivery of that request to the CitySearch content site (309), the site processes the user's location and sends all of the nearby Mexican restaurants in its directory back down to the browser.

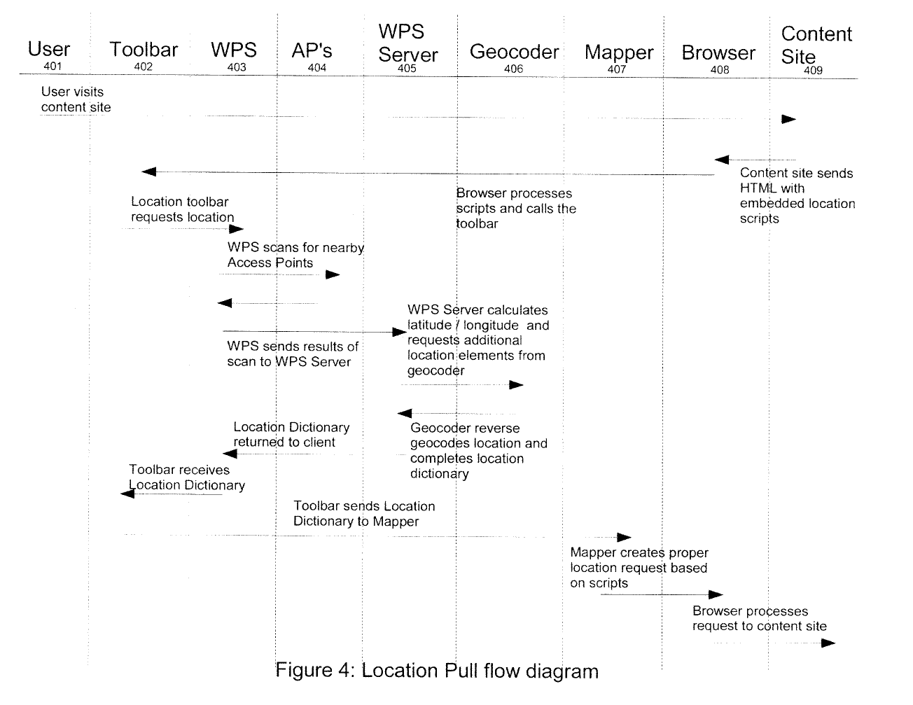

FIG. 4 depicts a location pull model flow diagram. In the location pull model, a content site (409) itself initiates the interaction and includes scripts written to interact with the toolbar (402). As described in U.S. Provisional Patent Application No. 60/821,479, incorporated above, the content site (409) can include scripts within its HTML code that initiate a location query using the toolbar. When a user visits a particular web site, the browser (408) downloads the location scripts and processes them. If the location toolbar (402) is installed, the browser (408) will use the scripts to initiate a location lookup using the location toolbar (402). The location toolbar (402) requests the device's current location from the WPS location client (403), which scans for all nearby access points (404). All the access points (404) in range of the device respond. That collection of access points (404) is returned to the WPS client (403) and then sent off to the WPS Server (405) to calculate the latitude and longitude of the device. After completing that calculation, the WPS Server (405) uses the geocoder (406) to complete the location dictionary, which is then send back down to the WPS client (403) and toolbar (402).

The mapper (407) then uses the location dictionary to construct the location message as requested by the content site (409) in its scripts. The browser (408) sends the location elements, in the specific format, to the content site (409) for processing.

For example, a toolbar user visits starbucks.com to find the nearest Starbucks store. The user enters www.starbucks.com into their browser and the browser makes the request. The server at starbucks.com returns the HTML code to the browser to render the Starbucks home page. Within the HTML is location Javascript code that tells the browser to get the user's location and format it with street address and zip code. The browser uses the location toolbar, as described above, to get the location and format the location elements properly, and the browser then sends those back to the Starbucks.com server. The server receives the location information and customizes the home page to include a map to the nearest store, along with store specific and area specific promotions.

In addition to providing seamless access to local content and localized communications, the toolbar also acts as a platform for local advertising. The user's location can be utilized by the web content site not only to display relevant local content but also to display local advertisements. In addition, the toolbar itself can be used for advertising. Local advertisements can be placed on the toolbar itself by merchants. These advertisements can be targeted to users based on their current location. For example, a toolbar can be configured to post a message on the user's device such as “Feeling tired? There is a Starbucks 300 ft away from you right now.” when the toolbar detects the user is near a Starbucks. In another example, buttons on the toolbar change based on the user's location and user's proximity to participating retailers.

As will be realized, the invention is capable of other and different embodiments and its several details may be capable of modifications in various respects, all without departing from the invention as set out in the appended claims. For example, the geocoder and map data can reside on the mobile device, and the WPS client can be designed to perform the functions of the WPS server, described above. In such an embodiment, the mobile device does not need to make a request outside the mobile device to generate the location dictionary for the user's current location. Accordingly, the drawings and description are to be regarded as illustrative in nature and not in a restrictive of limiting sense, with the scope of the application being indicated in the claims.

What is claimed is:

1. A utility to invoke web services with information identifying an estimated geographic position of a user, comprising:
a geographic position estimating engine for periodically estimating a geographic position of the user in a first predetermined position information format;
a database of website entries stored in an electronically readable medium, each entry specifying a network address of a web service and identifying a corresponding format the web service expects when receiving position information as a web service parameter;
logic for detecting web service activation, for accessing the database to identify the expected format for the activated web service, and for invoking transformation logic;
transformation logic for transforming position information in the first predetermined format into position information encoded in the identified format for the activated web service; and
logic to issue the web service activation with the position information in the transformed format.

2. The utility of claim 1, wherein the logic for detecting web service activation is invoked in response to a user web browse action.

3. The utility of claim 1, wherein the logic for detecting web service activation is invoked in response to program code included in a website.

4. The utility of claim 1, wherein the geographic position estimating engine estimates the geographic position of the user based on receiving messages from a Wi-Fi access points within range of a Wi-Fi enabled device of the user.

5. The utility of claim 1, wherein the position information encoded in the identified format includes at least one of latitude, longitude, street address, city, state, province, county, zip code, census tract, region, country, and time zone.
